(19) United States
(12) Patent Application Publication
(10) Pub. No.: US 2025/0021387 A1
(43) Pub. Date: Jan. 16, 2025

(54) ASSIGNMENT OF DATA STORAGE APPLICATION PROCESSING TO PROCESSOR CORES THAT ARE SHARED WITH A CONTAINERIZED SERVICE IN A DATA STORAGE SYSTEM

(71) Applicant: Dell Products L.P., Round Rock, TX (US)

(72) Inventors: Vladimir Shveidel, Pardes-Hana (IL); Roy Koren, KFAR SABA (IL)

(21) Appl. No.: 18/219,872

(22) Filed: Jul. 10, 2023

(51) Int. Cl. G06F 9/50; G06F 11/34

(52) U.S. Cl. CPC G06F 9/5027; G06F 11/3433

(57) ABSTRACT

Performance metrics are continuously monitored for each processor core in a shared portion of multiple processor cores in a data storage system. Each processor core in the shared portion is shared between a storage system application located in the data storage system and a containerized service also located in the data storage system. The monitored performance metrics indicate I/O request processing latency and an amount of the processing capacity of each individual processor core in the shared portion of the processor cores that is available for use by the storage system application. Based on the performance metrics, the I/O request processing is preferentially assigned to processor cores that have relatively lower I/O request processing latency, and the background work item processing is preferentially assigned to processor cores that have relatively higher amounts of capacity available for use by the storage system application.

### TECHNICAL FIELD

The present disclosure relates generally to data storage systems that host containerized services.

### BACKGROUND

Data storage systems are arrangements of hardware and software that are coupled to non-volatile data storage drives, such as solid state drives and/or magnetic disk drives. The data storage system services host I/O requests received from physical and/or virtual host machines (“hosts”). The host I/O requests received by the data storage system specify host data that is written and/or read by the hosts. The data storage system executes software that processes the host I/O requests by performing various data processing tasks to efficiently organize and persistently store the host data in the non-volatile data storage drives of the data storage system.

### SUMMARY

In the disclosed technology, performance metrics are continuously monitored for each processor core in a shared portion of multiple processor cores located in a data storage system. Each processor core in the shared portion of the processor cores is shared between a storage system application located in the data storage system and a containerized service also located in the data storage system. The monitored performance metrics indicate host I/O request processing latency and an amount of the processing capacity of each individual processor core in the shared portion of processor cores that is available for use by the storage system application. Host I/O request processing and background work item processing performed by the storage system application are assigned to individual processor cores based on the performance metrics. The host I/O request processing and the background work item processing performed by the storage system application are assigned to processor cores such that the host I/O request processing is preferentially assigned to processor cores that have relatively lower host I/O request processing latency than other processor cores, and the background work item processing is preferentially assigned to processor cores that have higher amounts of processing capacity available for use by the storage system application than other processor cores.

In some embodiments, the performance metrics monitored for each processor core in the shared portion of the processor cores include a per-core average host I/O (Input/Output) request processing latency. In such embodiments, assigning of host I/O request processing and background work item processing performed by the storage system application includes preferentially assigning host I/O request processing to processor cores in the shared portion of the processor cores that have lower average host I/O request processing latency than other processor cores in the shared portion of the processor cores.

In some embodiments, the performance metrics monitored for each processor core in the shared portion of the processor cores include a per-core percentage of total processing capacity consumed by execution of the containerized service. In such embodiments, the assigning of host I/O request processing and background work item processing performed by the storage system application includes preferentially assigning background work item processing to processor cores in the shared portion of the processor cores that have a lower percentage of their total processing capacity consumed by execution of the containerized service than other processor cores in the shared portion of the processor cores.

In some embodiments, the performance metrics monitored for each processor core in the shared portion of the processor cores include a per-core total utilization. In such embodiments, the assigning of host I/O request processing and background work item processing performed by the storage system application includes assigning processing of at least one host I/O request to one or more processor cores in the shared portion of the processor cores in response to detecting that those processor cores have a total utilization that is less than a predetermined low utilization threshold.

In some embodiments, the data storage system further includes a non-shared portion of processor cores, and each processor core in the non-shared portion of processor cores in the data storage system exclusively executes only one of either host I/O request processing or background work item processing performed by the storage system application. Each processor core in the shared portion of processor cores in the data storage system executes, in addition to the containerized service, only one of either i) host I/O request processing performed by the storage system application, or ii) background work item processing performed by the storage system application.

In some embodiments, the containerized service provides a file-based data storage service, and the storage system application provides a block-based data storage service.

In some embodiments, the host I/O request processing performed by the storage system application is processing of host I/O requests received by the data storage system from at least one host computing device, and the background work item processing performed by the storage system application includes flushing host data stored in a cache of the data storage system to at least one non-volatile data storage drive. Other examples of background work item processing include compression, deduplication, and/or encryption of host data.

The foregoing summary does not indicate required elements, or otherwise limit the embodiments of the disclosed technology described herein. The technical features described herein can be combined in any specific manner, and all combinations may be used to embody the disclosed technology.

### BRIEF DESCRIPTION OF THE DRAWINGS

The objects, features and advantages of the disclosed technology will be apparent from the following description of embodiments, as illustrated in the accompanying drawings in which like reference numbers refer to the same parts throughout the different views. The drawings are not necessarily to scale, emphasis instead being placed on illustrating the principles of the disclosed technology.

FIG. 1 is a block diagram showing an illustrative example of a data storage system including an embodiment of the disclosed technology;

FIG. 2 is a block diagram showing an example of using shared processor cores and non-shared processor cores located in the processor cores of a data storage system;

FIG. 3 is a block diagram showing another example of using shared processor cores and non-shared processor cores located in the processor cores of a data storage system;

FIG. 4 is a flow chart showing steps performed in some embodiments to assign host I/O request processing to processor cores in a data storage system;

FIG. 5 is another flow chart showing steps performed in some embodiments to assign background work item processing to processor cores in a data storage system; and

FIG. 6 is a flow chart showing an example of steps performed in some embodiments.

### DETAILED DESCRIPTION

Embodiments will now be described with reference to the figures. The embodiments described herein are provided only as examples, in order to illustrate various features and principles of the disclosed technology, and are not limiting. The embodiments of disclosed technology described herein are integrated into a practical solution for sharing the capacity of processor cores with a containerized service that executes in a data storage system.

In the disclosed technology, performance metrics are continuously monitored for each processor core in a shared portion of multiple processor cores located in a data storage system. Each processor core in the shared portion of the processor cores is shared between a storage system application located in the data storage system and a containerized service also executing in the data storage system. The monitored performance metrics indicate host I/O request processing latency and an amount of the processing capacity of each individual processor core in the shared portion of processor cores that is available for use by the storage system application, and host I/O request processing and/or background work item processing performed by the storage system application are assigned to individual processor cores based on the performance metrics. The host I/O request processing is preferentially assigned to processor cores that have relatively lower host I/O request processing latency than other processor cores, and the background work item processing is preferentially assigned to processor cores that have higher amounts of processing capacity available for use by the storage system application than other processor cores.

The performance metrics monitored for each processor core in the shared portion of the processor cores may include a per-core average host I/O (Input/Output) request processing latency, and assigning of host I/O request processing and/or background work item processing performed by the storage system application may include preferentially assigning host I/O request processing to processor cores in the shared portion of the processor cores that have lower average host I/O request processing latency than other processor cores in the shared portion of the processor cores.

The performance metrics monitored for each processor core in the shared portion of the processor cores may include a per-core percentage of total processing capacity consumed by execution of the containerized service, and the assigning of host I/O request processing and/or background work item processing performed by the storage system application may include preferentially assigning background work item processing to processor cores in the shared portion of the processor cores that have a lower percentage of their total processing capacity consumed by execution of the containerized service than other processor cores in the shared portion of the processor cores.

The performance metrics monitored for each processor core in the shared portion of the processor cores may include a per-core total utilization, and the assigning of host I/O request processing and/or background work item processing performed by the storage system application may include assigning processing of at least one host I/O request to one or more processor cores in the shared portion of the processor cores in response to detecting that those processor cores have a total utilization that is less than a predetermined low utilization threshold.

The data storage system may further include a non-shared portion of processor cores, and each processor core in the non-shared portion of processor cores in the data storage system may exclusively executes only one of either host I/O request processing or background work item processing performed by the storage system application. Each processor core in the shared portion of processor cores in the data storage system may execute, in addition to the containerized service, only one of either i) host I/O request processing performed by the storage system application, or ii) background work item processing performed by the storage system application.

The containerized service may, for example, provide a file-based data storage service. The storage system application may, for example, provide a block-based data storage service.

The host I/O request processing performed by the storage system application may be processing of host I/O requests received by the data storage system from at least one host computing device, and the background work item processing performed by the storage system application may include flushing host data stored in a cache of the data storage system to at least one non-volatile data storage drive, as well as compression, deduplication, and/or encryption of host data stored in either the cache and/or in the physical non-volatile data storage drives of the data storage system.

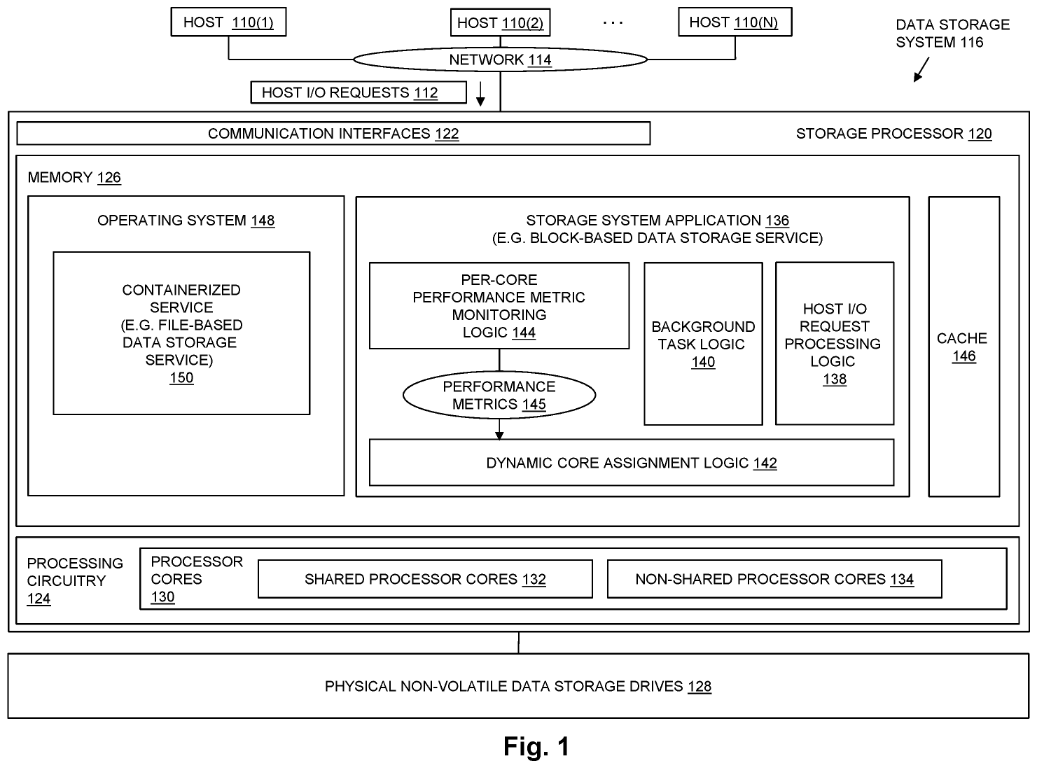

FIG. 1 is a block diagram showing an operational environment for the disclosed technology, including an example of a data storage system in which the disclosed technology is embodied. FIG. 1 shows a number of physical and/or virtual Host Computing Devices 110, referred to as “hosts”, and shown for purposes of illustration by Hosts 110(1) through 110(N). The hosts and/or applications executing thereon may access non-volatile data storage provided by Data Storage System 116, for example over one or more networks, such as a local area network (LAN), and/or a wide area network (WAN) such as the Internet, etc., and shown for purposes of illustration in FIG. 1 by Network 114. Alternatively, or in addition, one or more of Hosts 110 and/or applications accessing non-volatile data storage provided by Data Storage System 116 may execute within Data Storage System 116.

Data Storage System 116 includes at least one Storage Processor 120 that is communicably coupled to both Network 114 and Physical Non-Volatile Data Storage Drives 128, e.g. at least in part though one or more Communication Interfaces 122. No particular hardware configuration is required, and Storage Processor 120 may be embodied as any specific type of device that is capable of processing host input/output (I/O) requests (e.g. I/O read requests and I/O write requests, etc.), and of persistently storing host data.

The Physical Non-Volatile Data Storage Drives 128 may include physical data storage drives such as solid state drives, magnetic disk drives, hybrid drives, optical drives, and/or other specific types of drives.

A Memory 126 in Storage Processor 120 stores program code that is executed on Processing Circuitry 124, as well as data generated and/or processed by such program code. Memory 126 may include volatile memory (e.g. RAM), and/or other types of memory.

Memory 126 may include and/or be communicably coupled with a Cache 146. Cache 146 may be used to cache host data received by Storage Processor 120 from Hosts 110 (e.g. host data indicated in I/O write requests). Host data stored in Cache 146 is flushed from time to time from Cache 146 into Physical Non-Volatile Data Storage Drives 128.

Processing Circuitry 124 includes or consists of multiple Processor Cores 130, e.g. within one or more multi-core processor packages. Each processor core in Processor Cores 130 includes or consists of a separate processing unit, sometimes referred to as a Central Processing Unit (CPU). Each individual processor core in Processor Cores 130 is made up of separate electronic circuitry that is capable of independently executing instructions. Processor Cores 130 includes a shared portion, shown by Shared Processor Cores 132. Shared Processor Cores 132 are processor cores that are shared between Storage System Application 136 and Containerized Service 150. Processor Cores 130 also includes a non-shared portion, shown by Non-Shared Processor Cores 134. Non-Shared Processor Cores 134 are processor cores that are used exclusively by Storage System Application 136.

Processing Circuitry 124 and Memory 126 together form control circuitry that is configured and arranged to carry out various methods and functions described herein. The Memory 126 stores a variety of software components that may be provided in the form of executable program code. For example, Memory 126 may include software components such as Storage System Application 136 and Operating System 148. When program code stored in Memory 126 is executed by Processing Circuitry 124, Processing Circuitry 124 is caused to carry out the operations of the software components described herein. Although certain software components are shown in the Figures and described herein for purposes of illustration and explanation, those skilled in the art will recognize that Memory 126 may also include various other specific types of software components.

In the example of FIG. 1, Storage System Application 136 is an application executing in Data Storage System 116, and provides a block-based (aka “block level”) data storage service to one or more of the Hosts 110. The block-based data storage service provided by Storage System Application 136 processes block-based I/O requests received by Data Storage System 116 from Hosts 110. The block-based I/O requests processed by Storage System Application 136 enable the Hosts 110 to indicate blocks of host data that is written to and read from blocks of the non-volatile data storage that is served by Data Storage System 116. The block-based I/O requests processed by Storage System Application 136 are communicated to Data Storage System 116 by Hosts 110 using a block-based storage protocol that is supported by Storage System Application 136. In this way, Storage System Application 136 enables the Hosts 110 to connect to Data Storage System 116 using a block-based data storage protocol. Examples of block-based data storage protocols that may be supported by Storage System Application 136 in various embodiments include without limitation Fibre Channel (FC), Internet Small Computer Systems Interface (iSCSI), and/or Non-Volatile Memory Express (NVMe) protocols.

Storage System Application 136 may also provide its block-based data storage service to the Containerized Service 150.

Host I/O Request Processing Logic 138 performs host I/O request processing. The host I/O request processing performed by Host I/O Request Processing Logic 138 consists of in-line processing of block-based host I/O requests that are received by Data Storage System 116. In the case of a received I/O write request, Host I/O Request Processing Logic 138 performs all processing that is necessary to perform before an acknowledgement is returned to the host indicating that the host data indicated by the I/O write request has been securely stored by Data Storage System 116. Such processing includes securely storing the host data indicated by the I/O write request either into the Cache 146 and/or into Physical Non-Volatile Data Storage Drives 128. In the case of a received I/O read request, Host I/O Request Processing Logic 138 performs the processing that is necessary to perform before the host data requested by the I/O read request is returned to the host. Such processing includes reading the requested data from Cache 146 or Physical Non-Volatile Data Storage Drives 128, and may further include performing any additional data processing that may be necessary, such as decompression, decryption, etc., of the host data.

Background Task Logic 140 performs background work item processing. The background work item processing performed by Background Task Logic 140 is background processing of host data that is not performed in-line by Host I/O Request Processing Logic 138, and that may accordingly be deferred. Such background processing of host data performed by Background Task Logic 140 includes processing of host data indicated by an I/O write request that can be performed after an acknowledgement is returned to the host indicating that the host data indicated by the host I/O write request has been securely stored in the Data Storage System 116. One example of background work item processing that is performed by Background Task Logic 140 is flushing of host data indicated by I/O write requests from Cache 146 to Physical Non-Volatile Data Storage Drives 126. Other examples of background work item processing performed by Background Task Logic 140 are compression, deduplication, and/or encryption of host data stored in either Cache 146 and/or Physical Non-Volatile Data Storage Drives 128.

Containerized Service 150 is a containerized service that is installed in Operating System 148, and that executes in Data Storage System 116. Containerized Service 150 may, for example, include file-based data storage service logic that provides a file-level data storage service, and that is packaged with its own software logic, libraries, and/or configuration files in a software container that is installed into Operating System 148. For example, in some embodiments, Containerized Service 150 may be provided as a Docker container hosted in a Docker Engine, as developed by Docker, Inc.

Execution of Containerized Service 150 provides a file-based (aka “file-level”) data storage service to one or more of the Hosts 110. The file-based data storage service provided by Containerized Service 150 processes file-based I/O requests received by Data Storage System 116 from Hosts 110. The file-based I/O requests received by Data Storage System 116 from Hosts 110 and processed by Containerized Service 150 access files that are served by Containerized Service 150 to the Hosts 110, and that are stored in the Physical Non-Volatile Data Storage Drives 128. In this way, Containerized Service 150 provides file-level storage and acts as Network Attached Storage (NAS) for the Hosts 110. The file-based I/O requests processed by Containerized Service 150 are communicated to Data Storage System 116 by Hosts 110 using a file-based storage protocol that is supported by Containerized Service 150. Containerized Service 150 enables the Hosts 110 to connect to Data Storage System 116 using such a file-based storage protocol. Examples of file-based storage protocols that may be supported by Containerized Service 150 include without limitation Network File System (NFS) and/or Server Message Block (SMB) protocols.

Per-Core Performance Metric Monitoring Logic 144 continuously monitors one or more performance metrics for each individual processor core in Shared Processor Cores 132, and may also monitor one or more performance metrics for each processor core in Non-Shared Processor Cores 134. The monitored performance metrics are shown by Performance Metrics 145, and are passed from Per-Core Performance Metric Monitoring Logic 144 to Dynamic Core Assignment Logic 142. The Performance Metrics 145 include indications of host I/O request processing latency and an amount of the processing capacity of each individual processor core in Shared Processor Cores 132 that is available for use by Storage System Application 136. Per-Core Performance Metric Monitoring Logic 144 may obtain one or more of Performance Metrics 145 by directly monitoring the performance of individual processor cores, and/or by obtaining, from time to time, performance metrics of individual processor cores from Operating System 148 or some other program code executing in Data Storage System 116.

Dynamic Core Assignment Logic 142 uses Performance Metrics 145 to determine how it dynamically assigns host I/O request processing performed by Host I/O Request Processing Logic 138 and background work item processing performed by Background Task Logic 140 to individual ones of the processor cores in Shared Processor Cores 132 and/or Non-Shared Processor Cores 134. For example, Dynamic Core Assignment Logic 142 may dynamically assign threads of execution of Host I/O Request Processing Logic 138 and threads of execution of Background Task Logic 140 to specific processor cores at specific times based on Performance Metrics 145. In this way, Dynamic Core Assignment Logic 142 assigns host I/O request processing and/or background work item processing performed by Storage System Application to individual ones of the processor cores in Shared Processor Cores 132 and/or Non-Shared Processor Cores 134 based on the performance metrics monitored for each individual processor core Shared Processor Cores 132. Dynamic Core Assignment Logic 142 preferentially assigns host I/O request processing performed by Host I/O Request Processing Logic 138 to processor cores that have relatively lower host I/O request processing latency than other processor cores host, and preferentially assigns r background work item processing performed by Background Task Logic 140 to processor cores in Shared Processor Cores 132 that have higher amounts of processing capacity available for use by the Storage System Application 136 than other processor cores in Shared Processor Cores 132. For example, based on the Performance Metrics 145, Dynamic Core Assignment Logic 142 assigns more host I/O request processing and/or background work item processing to one or more processor cores in Shared Processor Cores 132 that have relatively higher amounts of processing capacity available for use by Storage System Application 136, and less host I/O request processing and/or background work item processing to one or more other processor cores in Shared Processor Cores 132 that have relatively lower amounts of capacity available for use by Storage System Application 136 compared to other processor cores in Shared Processor Cores 132.

The Performance Metrics 145 monitored by Per-Core Performance Metric Monitoring Logic 144 for each processor core in Shared Processor Cores 132 may include a per-core average host I/O (Input/Output) request processing latency. For each processor core in Shared Processor Cores 132, the average host I/O request processing latency may be an average of the amounts of time that were needed to completely process individual host I/O requests that were processed by that processor during a period of time. Dynamic Core Assignment Logic 142 preferentially assigns host I/O request processing performed by Host I/O Request Processing Logic 138 to one or more processor cores in Shared Processor Cores 132 and/or Non-Shared Processor Cores 134 with lower average host I/O request processing latency than one or more other processor cores in Shared Processor Cores 132 and/or Non-Shared Processor Cores 134. Accordingly, Dynamic Core Assignment Logic 142 responds to Performance Metrics 145 by assigning more host I/O requests for processing to one or more processor cores in Shared Processor Cores 132 and/or Non-Shared Processor Cores 134 that had relatively lower average host I/O request processing latency during a previous time period than it assigns to one or more other processor cores in Shared Processor Cores 132 and/or Non-Shared Processor Cores 134 that had relatively higher average host I/O request processing latency during the previous time period.

The Performance Metrics 145 monitored by Per-Core Performance Metric Monitoring Logic 144 for each processor core in Shared Processor Cores 132 may also include a per-core percentage of total processing capacity consumed by execution of the Containerized Service 150. For each processor core in Shared Processor Cores 132, the percentage of total processing capacity consumed by execution of the Containerized Service 150 may be the percentage of the total processing capacity of that processor core that was used to execute the Containerized Service 150 during a period of time. Dynamic Core Assignment Logic 142 may respond to Performance Metrics 145 by preferentially assigning background work item processing performed by Background Task Logic 140 to one or more processor cores in Shared Processor Cores 132 and/or Non-Shared Processor Cores 134 that have a lower percentage of their total processing capacity consumed by execution of the Containerized Service 150 than one or more other processor cores in Shared Processor Cores 132 and/or Non-Shared Processor Cores 134. Accordingly, Dynamic Core Assignment Logic 142 responds to Performance Metrics 145 by assigning more background work item processing (e.g. flushing of more host data indicated by I/O write requests from Cache 146 to Physical Non-Volatile Data Storage Drives 126, and/or compression, deduplication, and/or encryption of more host data) to one or more processor cores in Shared Processor Cores 132 and/or Non-Shared Processor Cores 134 that had a relatively lower percentage of their total processing capacity consumed by execution of the Containerized Service 150 during a previous time period than it assigns to one or more other processor cores in Shared Processor Cores 132 and/or Non-Shared Processor Cores 134 that had a relatively higher percentage of their total processing capacity consumed by execution of the Containerized Service 150 during the previous time period.

The Performance Metrics 145 monitored by Per-Core Performance Metric Monitoring Logic 144 for each processor core in Shared Processor Cores 132 may include a per-core total utilization. The per-core total utilization of each processor core in Shared Processor Cores 132 may be a percentage of the total processing capacity of that processor core that was consumed by execution of both the Containerized Service 150 and the Storage System Application 136 during a given time period. Dynamic Core Assignment Logic 142 may operate based on Performance Metrics 145 by detecting that one or more processor cores in Shared Processor Cores 132 that were previously executing only background work items performed by Background Task Logic 140 had a total utilization that was less than a predetermined low utilization threshold during a period of time. In response to detecting that one or more processor cores in Shared Processor Cores 132 that were previously executing only background work items performed by Background Task Logic 140 had a total utilization that was less than a predetermined low utilization threshold during the previous time period, Dynamic Core Assignment Logic 142 assigns processing of at least one host I/O request by Host I/O Request Processing Logic 138 to those one or more processor cores.

As described above, Processor Cores 130 includes Shared Processor Cores 132 that execute both Containerized Service 150 and Storage System Application 136, and Non-Shared Processor Cores 134 that execute only Storage System Application 136. In addition, in some embodiments, Dynamic Core Assignment Logic 142 segregates processing of background work items and processing of host I/O requests by maintaining the following two sets of processor cores within Processor Cores 130: i) a first set of processor cores to which are assigned processing host I/O requests by execution of Host I/O Request Processing Logic 138, and ii) a second set of processor cores to which are assigned processing of background work items by execution of Background Task Logic 140. Each of these sets of processor cores maintained by Dynamic Core Assignment Logic 142 may include shared and/or non-shared processor cores. In general, any given processor core only belongs to one of the two sets at any given point in time. Dynamic Core Assignment Logic 142 varies the specific number of processors within each set over time, responsive to the current workload being presented to the Data Storage System 116.

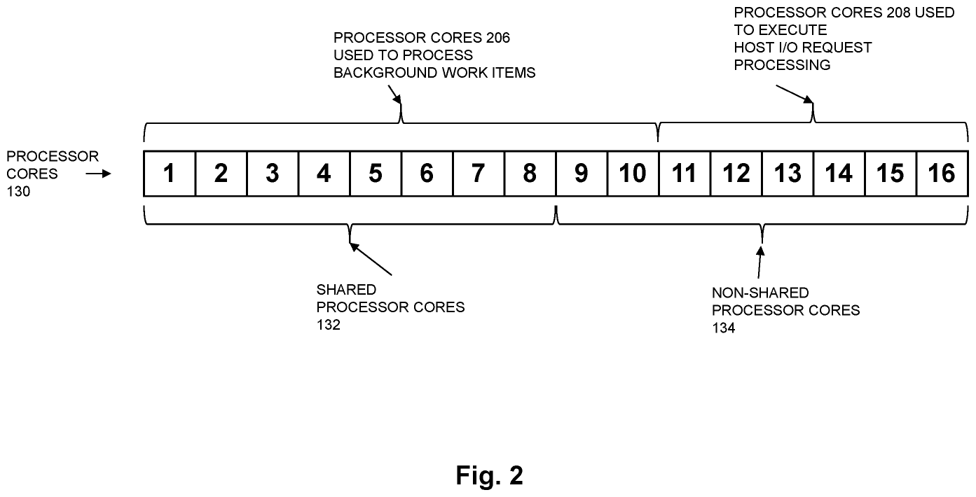

FIG. 2 shows an example in which Processor Cores 130 is made up of sixteen processor cores, with processor cores 1-8 in Shared Processor Cores 132, and processor cores 9-16 in Non-Shared Processor Cores 134. In the example of FIG. 2, processor cores 1-10 are in the set of processor cores 206 to which are assigned processing of host I/O requests by execution of Host I/O Request Processing Logic 138, and processor cores 11-16 are in the set of processor cores 308 to which are assigned processing of background work items by execution of Background Task Logic 140.

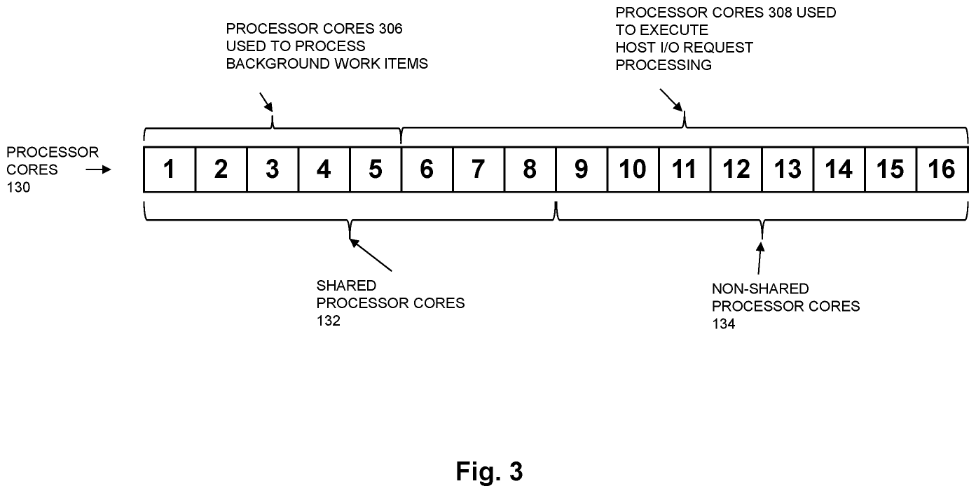

FIG. 3 shows another example in which Processor Cores 130 is made up of sixteen processor cores, again with processor cores 1-8 being in Shared Processor Cores 132, and processor cores 9-16 are in Non-Shared Processor Cores 134. However, in the example of FIG. 3, processor cores 1-5 are in the set of processor cores 306 to which are assigned the processing of host I/O requests by execution of Host I/O Request Processing Logic 138, and processor cores 6-16 are in the set of processor cores 308 to which are assigned processing of background work items by execution of Background Task Logic 140.

As shown in FIGS. 2-3, individual Shared Processor Cores 132 may be either in the set of processor cores that processes host I/O requests by execution of Host I/O Request Processing Logic 138, or in the set of processor cores that processes background work items by execution of Background Task Logic 140.

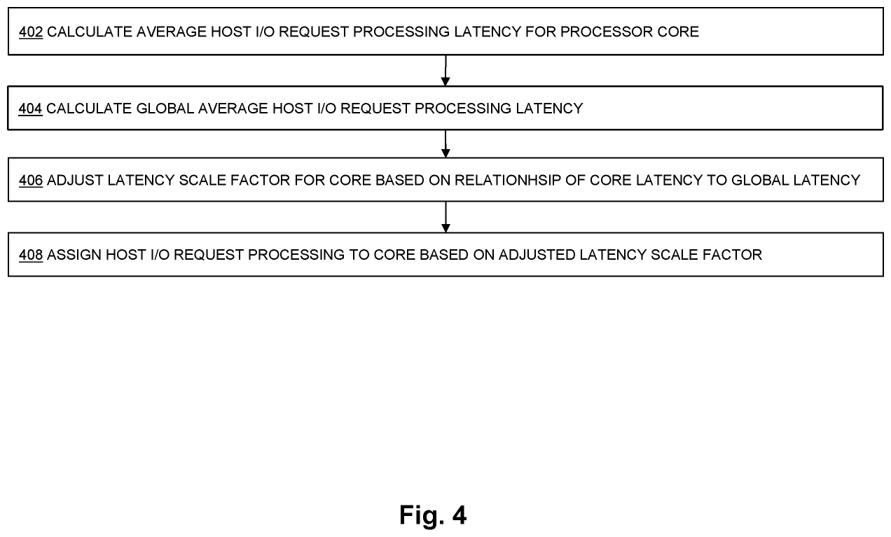

FIG. 4 shows an example of steps performed to assign the processing of host I/O requests by Host I/O Request Processing Logic 138 to specific processor cores within those Shared Processor Cores 132 and/or Non-Shared Processor Cores 134 to which host I/O request processing is currently being assigned, e.g. processor cores 6-16 in the example of FIG. 3. The steps in FIG. 4 are performed separately for each one of the processor cores in Shared Processor Cores 132 and/or Non-Shared Processor Cores 134 to which host I/O request processing is currently being assigned.

At step 402, an average host I/O request processing latency for the processor core is calculated by Per-Core Performance Metric Monitoring Logic 144. The average host I/O request processing latency for the processor core is an average of the amounts of time needed to complete processing of the individual host I/O requests processed by the processor core during a period of time.

At step 404, a global average host I/O request processing latency is calculated, e.g. by Per-Core Performance Metric Monitoring Logic 144. The global average host I/O request processing latency is an average of the amounts of time needed to complete processing of the individual host I/O requests processed by the processor cores in the set of processor cores to which host I/O request processing is currently being assigned (e.g. Processor Cores 308 in the example of FIG. 3) during a period of time. The average host I/O request processing latency for each shared processor core to which host I/O request processing is currently being assigned is brought as close as possible to the global average host I/O request processing latency.

At step 406, a latency scale factor for the processor core is adjusted based on the relationship of the average host I/O request processing latency for the processor core to the global average host I/O request processing latency. A separate latency scale factor is maintained at least for each shared processor core that is currently being used to perform processing of host I/O requests. The latency scale factor may be a percentage in the range of 1 to 100. Logically, the latency scale factor for a processor core may be an indication of the amount of capacity of the processor core that is available for use by the Storage System Application 136. During step 406, the average host I/O request processing latency for the processor core is compared to the global average host I/O request processing latency. If the average host I/O request processing latency is greater than the global average host I/O request processing latency, then the value of the latency scale factor for the processor core is decremented by one percent. Otherwise, the value of the latency scale factor for the processor core is incremented by one percent. The latency scale factor for each processor core may initially be set to 100 percent.

At step 408, Dynamic Core Assignment Logic 142 assigns the processing of host I/O requests to the processor core based on the value of the latency scale factor for the individual processor core, as previously adjusted in step 406. For example, at a given point in time, each processor core to which host I/O request processing is currently being assigned (e.g. each processor core in Processor Cores 308 in FIG. 3) may initially be assigned an equal proportion of all the host I/O request processing that currently needs to be performed by Host I/O Request Processing Logic 138. For example, if there are 11 processor cores to which host I/O request processing is currently being assigned, and there are 22 host I/O requests that currently need to be performed, each of the processor cores may initially be assigned processing of 2 of the host I/O requests. However, the actual amount of host I/O request processing assigned by Dynamic Core Assignment Logic 142 to an individual processor core is a percentage of the initially assigned equal proportion of all host I/O request processing that currently needs to be processed. The specific percentage of the equal proportion that is actually assigned to an individual shared processor core is equal to the latency scale factor for that processor core. For example, if the latency scale factor for the processor core is currently 50 percent, then the amount of host I/O request processing actually assigned to that processor core is 50 percent of an initially assigned equal proportion of the total amount of host I/O request processing that currently needs to be processed. For example, in a case where 2 host I/O requests were initially assigned for processing on each one of the processor cores currently performing processing of host I/O requests, only 1 host I/O request is actually assigned to any one of those processor cores that is a shared processor core and has a latency scale factor of 50 percent.

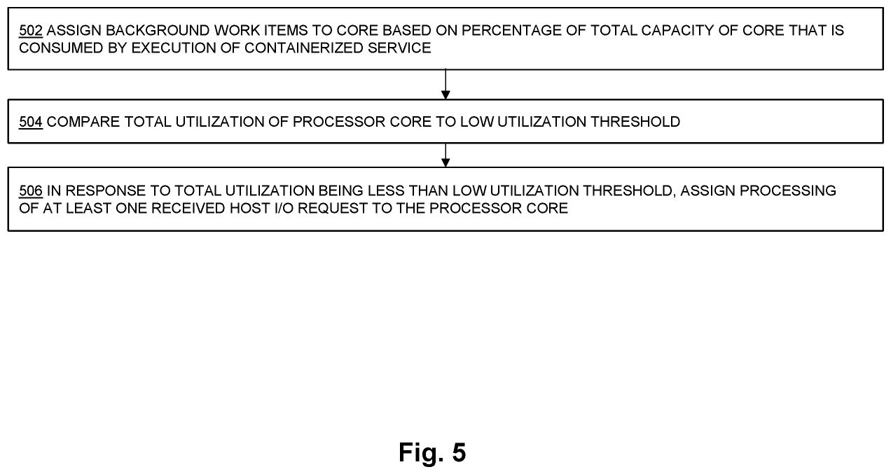

FIG. 5 is a flow chart showing steps performed by Dynamic Core Assignment Logic 142 to assign the processing of background work items performed by Background Task Logic 140 to those specific processor cores within those Shared Processor Cores 132 to which processing of background work items is currently being assigned, e.g. processor cores 1-5 in the example of FIG. 3.

The steps in FIG. 5 are performed separately for each one of the processor cores in Shared Processor Cores 132 to which processing of background work items is currently being assigned.

The steps shown in FIG. 5 are performed in response to the per-core percentage of total processing capacity consumed by execution of the containerized service performance metric, and to the per-core total utilization metric for each processor core.

At 502, Dynamic Core Assignment Logic 142 uses the per-core percentage of total processing capacity consumed by execution of the containerized service performance metric to assign background work item processing to the individual processor core. For example, in the case where the per-core percentage of the total processing capacity of a processor core consumed by execution of the containerized service performance metric is 50 percent, then 50 percent of the capacity of that processor core is the remaining available capacity for execution of the Storage System Application 136 on that processor core. The per-core remaining available capacity is used to determine how much background work item processing is assigned to individual processor cores. For example, at a given point in time, each processor core to which background work item processing is currently being assigned (e.g. each processor core in Processor Cores 306 in FIG. 3) may by default be initially assigned an equal proportion of all the background work item processing that currently needs to be performed by Background Task Logic 140. For example, if there are 5 processor cores to which background work item processing is currently being assigned, and there are 10 megabytes of host data that currently needs to be flushed from the Cache 146 to Physical Non-Volatile Data Storage Drives 128, each of the 5 processor cores may initially be assigned flushing of 2 megabytes. However, the actual amount of background work item processing assigned by Dynamic Core Assignment Logic 142 to an individual processor core may is a percentage of the initially assigned equal proportion of all background work item processing that currently needs to be processed. The specific percentage of the initial equal proportion actually assigned to a processor core is equal to the remaining available capacity for the processor core. For example, if the remaining available capacity for a processor core is currently 50 percent, then the amount of background work item processing actually assigned to that processor core is only 50 percent of an initially assigned equal proportion of the total amount of background item processing that currently needs to be processed. For example, in a case where 2 megabytes of flushing were initially assigned for processing on each one of the processor cores, only 1 megabyte of flushing is actually assigned to a processor core having a remaining available capacity of 50 percent.

In some cases, reducing the amount of work item processing assigned to individual processor cores may result in underutilization of some processor cores. To address this possibility, at step 504 the current value of the per-core total utilization metric for the processor core is compared to a low utilization threshold. At step 506, in response to the current value of the per-core total utilization metric for the processor core being less than the low utilization threshold, Dynamic Core Assignment Logic 142 assigns processing of some additional, fine-grained work to the processor core. For example, in response to the current value of the per-core total utilization metric for the processor core being less than the low utilization threshold, Dynamic Core Assignment Logic 142 may assign processing of at least one host I/O request to the processor core, e.g. to one of the processor cores 306 in FIG. 3 that is otherwise only being used to process background work items. In this way, the utilization of the processor core may advantageously be increased. The overall latency impact of assigning processing of a small number of host I/O requests to processor cores otherwise being used to perform background item processing is generally small and acceptable, while advantageously increasing per-processor core utilization. Accordingly, processing of only a small percentage of all host I/O requests is assigned for this purpose to processor cores otherwise being used to perform background work item processing. In addition, in some embodiments, scheduling of host I/O request processing may be prioritized over background work item processing in order to help mitigate any resulting latency impact on host I/O request processing.

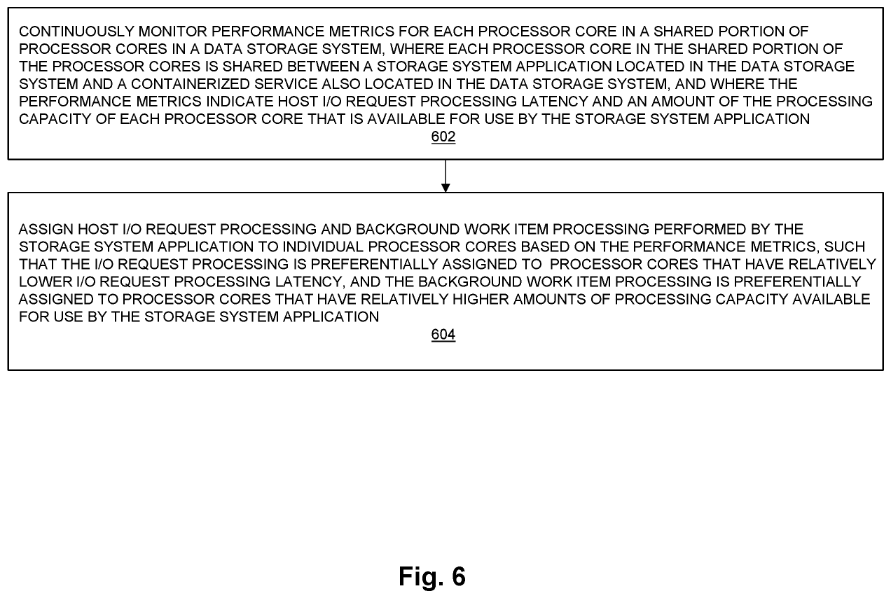

FIG. 6 is a flow chart showing an example of steps performed in some embodiments of the disclosed technology.

At step 602, performance metrics are continuously monitored for each processor core in a shared portion of processor cores in a data storage system. Each processor core in the shared portion of the processor cores is shared between a storage system application located in the data storage system and a containerized service also located in the data storage system. The performance metrics indicate I/O request processing latency and an amount of the capacity of each processor core in the shared portion of the processor cores that is available for use by the storage system application.

At step 604, based on the monitored performance metrics, host I/O request processing is preferentially assigned to individual processor cores that have lower I/O request processing latency than other processor cores, and background work item processing is preferentially assigned to individual processor cores that have higher amounts of capacity available for use by the storage system application than other processor cores.

The disclosed technology is integral to a practical technical solution for sharing processor cores with a containerized service that executes in a data storage system. Without the disclosed technology, a data storage application executing in a data storage system may attempt to operate without knowing the actual current “strengths” of the processor cores it shares with the containerized service that also executes in the data storage system. However, current strengths of individual processor cores need to reflect the independent operation of the containerized service, which may utilize different processor cores in different amounts at different times. Without the disclosed technology, the speed at which work can currently be performed by the data storage application may vary significantly between different processor cores, potentially resulting in performance degradation for the data storage system.

For example, without the disclosed technology, a data storage application may naively assign background work items equally across multiple shared processor cores, under the assumption that all of the shared processor cores have equal availability, and accordingly that similar amounts of work will complete in the same amount of time regardless of which specific processor cores they are assigned to. However, because of unequal loading of processor cores by the containerized application, some background work items executed on some shared processor cores may complete relatively quickly, while other background work items executed on other shared processor cores complete much later. In some cases, this uneven performance could cause the data storage application to have to wait until the background work item assigned to the slowest (i.e. least available) shared processor core completes before moving on. In the case of background work that performs cache flushing, assigning the same amounts of background work to relatively less available shared processor cores as is assigned to more available shared processor cores may cause overall cache evacuation speed to be reduced, potentially to the point where the processing of incoming I/O write requests is delayed as a result.

As will be appreciated by those skilled in the art, aspects of the technology disclosed herein may be embodied as a system, method, or computer program product. Accordingly, each specific aspect of the present disclosure may be embodied using hardware, software (including firmware, resident software, micro-code, etc.) or a combination of software and hardware. Furthermore, aspects of the technologies disclosed herein may take the form of a computer program product embodied in one or more non-transitory computer readable storage medium(s) having computer readable program code stored thereon for causing a processor and/or computer system to carry out those aspects of the present disclosure.

Any combination of one or more computer readable storage medium(s) may be utilized. The computer readable storage medium may be, for example, but not limited to, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any non-transitory tangible medium that can contain, or store a program for use by or in connection with an instruction execution system, apparatus, or device.

The figures include block diagram and flowchart illustrations of methods, apparatus(s) and computer program products according to one or more embodiments of the invention. It will be understood that each block in such figures, and combinations of these blocks, can be implemented by computer program instructions. These computer program instructions may be executed on processing circuitry to form specialized hardware. These computer program instructions may further be loaded onto programmable data processing apparatus to produce a machine, such that the instructions which execute on the programmable data processing apparatus create means for implementing the functions specified in the block or blocks. These computer program instructions may also be stored in a computer-readable memory that can direct a programmable data processing apparatus to function in a particular manner, such that the instructions stored in the computer-readable memory produce an article of manufacture including instruction means which implement the function specified in the block or blocks. The computer program instructions may also be loaded onto a programmable data processing apparatus to cause a series of operational steps to be performed on the programmable apparatus to produce a computer implemented process such that the instructions which execute on the programmable apparatus provide steps for implementing the functions specified in the block or blocks.

Those skilled in the art should also readily appreciate that programs defining the functions of the present invention can be delivered to a computer in many forms; including, but not limited to: (a) information permanently stored on non-writable storage media (e.g. read only memory devices within a computer such as ROM or CD-ROM disks readable by a computer I/O attachment); or (b) information alterably stored on writable storage media (e.g. floppy disks and hard drives).

While the invention is described through the above exemplary embodiments, it will be understood by those of ordinary skill in the art that modification to and variation of the illustrated embodiments may be made without departing from the inventive concepts herein disclosed.

What is claimed is:

1. A method comprising:
continuously monitoring performance metrics for each processor core in a shared portion of processor cores in a data storage system, wherein each processor core in the shared portion of the processor cores is shared between a storage system application located in the data storage system and a containerized service also located in the data storage system, and wherein the performance metrics indicate host I/O request processing latency and an amount of processing capacity of each processor core in the shared portion of the processor cores that is available for use by the storage system application; and
assigning host I/O request processing and background work item processing performed by the storage system application to individual processor cores based on the performance metrics, such that the host I/O request processing is preferentially assigned to processor cores that have relatively lower host I/O request processing latency than other processor cores, and the background work item processing is preferentially assigned to processor cores that have higher amounts of processing capacity available for use by the storage system application than other processor cores.

2. The method of claim 1, wherein the performance metrics monitored for each processor core in the shared portion of the processor cores include a per-core average host I/O (Input/Output) request processing latency; and
wherein the assigning of host I/O request processing and background work item processing performed by the storage system application includes preferentially assigning host I/O request processing to processor cores in the shared portion of the processor cores that have lower average host I/O request processing latency than other processor cores in the shared portion of the processor cores.

3. The method of claim 1, wherein the performance metrics monitored for each processor core in the shared portion of the processor cores include a per-core percentage of total processing capacity consumed by execution of the containerized service; and
wherein the assigning of host I/O request processing and background work item processing performed by the storage system application includes preferentially assigning background work item processing to processor cores in the shared portion of the processor cores that have a lower percentage of their total processing capacity consumed by execution of the containerized service than other processor cores in the shared portion of the processor cores.

4. The method of claim 1, wherein the performance metrics monitored for each processor core in the shared portion of the processor cores include a per-core total utilization; and
wherein the assigning of host I/O request processing and background work item processing performed by the storage system application includes assigning processing of at least one host I/O request to one or more processor cores in the shared portion of the processor cores in response to detecting that those processor cores have a total utilization that is less than a predetermined low utilization threshold.

5. The method of claim 1, wherein the data storage system further includes a non-shared portion of processor cores;
wherein each processor core in the non-shared portion of processor cores in the data storage system executes only one of the set consisting of i) host I/O request processing performed by the storage system application, and ii) background work item processing performed by the storage system application; and
wherein each processor core in the shared portion of processor cores in the data storage system executes, in addition to the containerized service, only one of the set consisting of i) host I/O request processing performed by the storage system application, and ii) background work item processing performed by the storage system application.

6. The method of claim 5, wherein at least one of the processor cores in the non-shared portion of the processor cores in the data storage system executes host I/O request processing; and
wherein at least one of the processor cores in the non-shared portion of the processor cores in the data storage system executes background work items.

7. The method of claim 1, wherein the containerized service provides a file-based data storage service; and
wherein the storage system application provides a block-based data storage service.

8. The method of claim 7, wherein the host I/O request processing performed by the storage system application comprises processing of host I/O requests received by the data storage system from at least one host computing device; and
wherein the background work item processing performed by the storage system application includes flushing host data stored in a cache of the data storage system to at least one non-volatile data storage drive of the data storage system.

9. A data storage system comprising:
processing circuitry and a memory;
a plurality of non-volatile data storage drives; and
wherein the memory has program code stored thereon, wherein the program code, when executed by the processing circuitry, causes the processing circuitry to:
continuously monitor performance metrics for each processor core in a shared portion of processor cores in the data storage system, wherein each processor core in the shared portion of the processor cores is shared between a storage system application located in the data storage system and a containerized service also located in the data storage system, and wherein the performance metrics indicate host I/O request processing latency and an amount of processing capacity of each processor core in the shared portion of the processor cores that is available for use by the storage system application, and
assign host I/O request processing and background work item processing performed by the storage system application to individual processor cores based on the performance metrics, such that the host I/O request processing is preferentially assigned to processor cores that have relatively lower host I/O request processing latency than other processor cores, and the background work item processing is preferentially assigned to processor cores that have higher amounts of processing capacity available for use by the storage system application than other processor.

10. The data storage system of claim 9, wherein the performance metrics monitored for each processor core in the shared portion of the processor cores include a per-core average host I/O (Input/Output) request processing latency; and
wherein the assignment of host I/O request processing and background work item processing performed by the storage system application includes preferentially assigning host I/O request processing to processor cores in the shared portion of the processor cores that have lower average host I/O request processing latency than other processor cores in the shared portion of the processor cores.

11. The data storage system of claim 9, wherein the performance metrics monitored for each processor core in the shared portion of the processor cores include a per-core percentage of total processing capacity consumed by execution of the containerized service; and
wherein the assignment of host I/O request processing and background work item processing performed by the storage system application includes preferentially assigning background work item processing to processor cores in the shared portion of the processor cores that have a lower percentage of their total processing capacity consumed by execution of the containerized service than other processor cores in the shared portion of the processor cores.

12. The data storage system of claim 9, wherein the performance metrics monitored for each processor core in the shared portion of the processor cores include a per-core total utilization; and
wherein the assignment of host I/O request processing and background work item processing performed by the storage system application includes assigning processing of at least one host I/O request to one or more processor cores in the shared portion of the processor cores in response to detecting that those processor cores have a total utilization that is less than a predetermined low utilization threshold.

13. The data storage system of claim 9, wherein the data storage system further includes a non-shared portion of processor cores;
wherein each processor core in the non-shared portion of processor cores in the data storage system executes only one of the set consisting of i) host I/O request processing performed by the storage system application, and ii) background work item processing performed by the storage system application; and
wherein each processor core in the shared portion of processor cores in the data storage system executes, in addition to the containerized service, only one of the set consisting of i) host I/O request processing performed by the storage system application, and ii) background work item processing performed by the storage system application.

14. The data storage system of claim 13, wherein at least one of the processor cores in the non-shared portion of the processor cores in the data storage system executes host I/O request processing; and
wherein at least one of the processor cores in the non-shared portion of the processor cores in the data storage system executes background work items.

15. The data storage system of claim 9, wherein the containerized service provides a file-based data storage service; and
wherein the storage system application provides a block-based data storage service.

16. The data storage system of claim 15, wherein the host I/O request processing performed by the storage system application comprises processing of host I/O requests received by the data storage system from at least one host computing device; and
wherein the background work item processing performed by the storage system application includes flushing host data stored in a cache of the data storage system to at least one non-volatile data storage drive of the data storage system.

17. A computer program product including a non-transitory computer readable medium having instructions stored thereon, wherein the instructions, when executed on processing circuitry, cause the processing circuitry to perform steps including:
continuously monitoring performance metrics for each processor core in a shared portion of processor cores in a data storage system, wherein each processor core in the shared portion of the processor cores is shared between a storage system application located in the data storage system and a containerized service also located in the data storage system, and wherein the performance metrics indicate host I/O request processing latency and an amount of processing capacity of each processor core in the shared portion of the processor cores that is available for use by the storage system application; and
assigning host I/O request processing and background work item processing performed by the storage system application to individual processor cores based on the performance metrics, such that the host I/O request processing is preferentially assigned to processor cores that have relatively lower host I/O request processing latency than other processor cores, and the background work item processing is preferentially assigned to processor cores that have higher amounts of processing capacity available for use by the storage system application than other processor cores.
